(19) United States
(12) Patent Application Publication
(10) Pub. No.: US 2020/0193115 A1
(43) Pub. Date: Jun. 18, 2020

(54) Nanocontact Molding and Casting: from 3D Fingerprint Phantoms to Designed Nanostructures

(71) Applicant: Simon Fraser University, Burnaby (CA)

(72) Inventors: Clayton W. SCHULTZ, Maple Ridge (CA); Jessica X. H. WONG, Vancouver (CA); Hua-Zhong YU, Burnaby (CA)

(21) Appl. No.: 16/383,393

(22) Filed: Apr. 12, 2019

Related U.S. Application Data
(60) Provisional application No. 62/780,872, filed on Dec. 17, 2018.

(51) Int. Cl. G06K 9/00

(52) U.S. Cl. CPC G06K 9/001; G06F 21/32; G06K 9/00013

(57) ABSTRACT

A method for fabricating a mold. The mold may comprise mold features with nanometer-scale resolution or minimum dimensions (e.g. the mold replicates nanometer-scale features of a master). The mold may comprise mold features with nanometer to micrometer-scale resolution or minimum dimensions (e.g. the mold replicates nanometer to micrometer-scale features of a master). The method may comprise providing a plate; applying a solvent to a first surface of the plate; allowing the solvent to penetrate from the first surface into the plate to thereby soften a first region of the plate, the first region of the plate including the first surface; pressing a master against the first region of the plate after the first region of the plate has softened to thereby deform at least a portion of the first region into a negative mold; and removing the master from contact with the plate.

### REFERENCE TO RELATED APPLICATIONS

This application claims the benefit under 35 USC 119 of U.S. application No. 62/780,872 filed 17 Dec. 2018 which is hereby incorporated herein by reference.

### TECHNICAL FIELD

This invention relates to nanocontact molding for fabricating microstructures and nanostructures. Particular embodiments provide methods and apparatus for molding of fingerprint phantoms.

### BACKGROUND

The ridges on our fingertips form unique patterns known as fingerprints that are most popularly known in the context of personal identification applications. For example, forensic science relies heavily on fingerprints collected at crime scenes as evidence. As another non-liming example, fingerprint scanning systems are commonly used at borders, in corporate buildings, and for our mobile devices (e.g. smartphones, tablet computers, and laptops) to keep our personal identity and data safe. Typically, fingerprint identification relies on a collection of one or more fingerprint databases for comparison and matching. Historically fingerprints were recorded by smearing ink on a fingertip and pressing the fingertip onto paper to form physical fingerprint impressions. Today, digital fingerprint scanners are often employed to record fingerprints for subsequent matching.

Fingerprint scanning apparatus and techniques are varied. Optical scanners observe lighting differences absorbed and/or reflected by the ridges and valleys of a fingerprint. Capacitive scanners utilize an array of micro-capacitors to resolve capacitance difference between ridges and air. Ultrasound scanners record ridge location by detecting the echo of projected acoustic pulses.

It is desirable for fingerprint scanners to be robust to accommodate a wide range of user conditions. It is desirable for fingerprint scanners to be accurate to ensure correct and consistent fingerprint matching. Before certification, fingerprint scanners are typically evaluated through standardized testing. In a typical testing process, a fingerprint scanner is first evaluated with sine wave and ronchi grating targets, which have defined feature size, relief, and grey levels. By imaging targets, the scanner's resolution can be determined, sensitivity adjusted, and operating parameters calibrated. Subsequently, a fingerprint scanner is typically tested with actual fingerprints for quality and matching analysis. Employing people to use their fingerprints for testing and calibrating is costly, time consuming, and has many sources of uncontrollable errors due to, for example, fingertip pressure, finger conditions, sweat levels, fingerprint type, etc. To reduce development costs, manufacturers may calibrate and test fingerprint scanners using so-called “fingerprint phantoms” that bear the same structural and physical characteristics of fingerprints.

A fingerprint phantom is a specific example of an imaging phantom (sometimes referred to herein as a phantom). An imaging phantom may mimic the properties of biological tissues/organs, for example, to test biomedical diagnostic devices (MRI, CT, and ultrasound machine as examples) for accuracy and resolution calibration. The physical properties and dimensions of phantoms are desirably accurately defined to facilitate more precise calibration. Many types of phantoms with a large range of complexity exist, from simple blocks of gelatinous water of certain densities to full body phantoms containing a bone-analog skeletal system, fake organs, and tissue regions mimicking muscle, skin and fatty tissue. There is a general desire for fingerprint phantoms to test fingerprint scanners due to the exponential increase of adapting fingerprint-based biometric systems for both stationary and mobile electronic devices as mentioned above.

Previously, non-permanent gelatin phantoms have been employed. Non-permanent gelatin phantoms can be readily constructed by molding impressions of fingers into crafting plastics (e.g. Utile Plast™, Freeplastic™) and silicone rubbers. Gelatin phantoms approximate finger ridge relief and electrical resistance of human tissue. However, because gelatin phantoms dry out and distort, they are not suitable for practical calibration applications.

It is known to employ three-dimensional printing technology to fabricate a finger print phantom based on a three-dimensional image created from a two-dimensional fingerprint scan. In such cases, the resolution of the fingerprint phantoms is limited by the three-dimensional printer and the simulated ridges may not incorporate the subtleties (particularly height variability) of real ridges.

It is also known to fabricate polydimethylsiloxane (PDMS) phantoms molded from a simulated ridge pattern etched in silicon. Such PDMS phantoms were developed to test ultrasound scanners. In such PDMS phantoms, the simulated ridge pattern is expensive to fabricate and the simulated ridges typically do not contain the subtleties (particularly height variability) of real ridges.

There remains a general desire for a simple to execute, low-cost method for creating accurate, long-lasting fingerprint phantoms.

Beyond making fingerprint phantoms, there is a general desire to fabricate designed nanostructures. For example, there is a general desire for inexpensive mold materials for lithography-free fabrication of large area nanostructures that can be conducted in a standard laboratory setting. There is also a general desire for inexpensive mold materials for lithography-free fabrication of large area nanostructures that can be conducted in a standard laboratory setting without specialized equipment.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method for fabricating a nanocontact mold. The method may comprise providing a plate, applying a solvent to a first surface of the plate, allowing the solvent to penetrate from the first surface into the plate, to soften a first region of the plate, the first region of the plate including the first surface, pressing a master against the first region of the plate after the first region of the plate has softened to thereby deform at least a portion of the first region into a negative mold, and removing the master from contact with the plate.

In some embodiments, at least some of the solvent is removed from the first region of the plate after allowing the solvent to penetrate from the first surface into the plate to soften the first region of the plate. In some embodiments, at least some of the solvent is removed from the first region of the plate after pressing the master against the first region of the plate. In some embodiments, at least some of the solvent is removed from the first region of the plate, wherein removing at least some of the solved from the first region of the plate is effected by pressing the master against the first region of the plate.

In some embodiments, the at least some of the solvent comprises at least 50% of the solvent applied to the first surface of the plate. In some embodiments, the at least some of the solvent comprises at least 70% of the solvent applied to the first surface of the plate. In some embodiments, the at least some of the solvent comprises at least 90% of the solvent applied to the first surface of the plate.

In some embodiments, the at least some of the solvent is removed from the first region of the plate between 4 seconds and 120 seconds after applying the solvent to the first surface of the plate. In some embodiments, the at least some of the solvent is removed from the first region of the plate between 40 seconds and 60 seconds after applying the solvent to the first surface of the plate. In some embodiments, the at least some of the solvent is removed from the first region of the plate between 4 seconds and 16 seconds after applying the solvent to the first surface of the plate. In some embodiments, the length of time before the at least some of the solvent is removed from the first region is dependent on a desired depth of the first region. In some embodiments, the length of time before the at least some of the solvent is removed from the first region is dependent on a composition of the solvent. In some embodiments, the length of time before the at least some of the solvent is removed from the first region is dependent on a composition of the plate. In some embodiments, the length of time before the at least some of the solvent is removed from the first region is dependent on a porosity of the plate. In some embodiments, the length of time before the at least some of the solvent is removed from the first region is dependent on a minimum dimension of the features of the master.

In some embodiments, the first region has a depth in the range of 15 μm to 45 μm. In some embodiments, the first region has a depth in the range of 25 μm to 30 μm. In some embodiments, the first region has a depth greater than twice the height of a largest feature of the master. In some embodiments, the first region has a depth greater than five times the height of a largest feature of the master.

In some embodiments, the plate comprises a polycarbonate plate. In some embodiments, the solvent is acetone. In some embodiments, the solvent comprises at least 60% acetone (by weight). In some embodiments, the solvent comprises at least 90% acetone (by weight). In some embodiments, the solvent is ethyl acetate. In some embodiments, the solvent is nail polish remover.

In some embodiments, the first surface of the polycarbonate is cleaned before applying the solvent to the first surface. In some embodiments, the first surface of the polycarbonate is cleaned with ethanol before applying the solvent to the first surface. In some embodiments, the first surface of the polycarbonate is cleaned with ethanol and deionized water before applying the solvent to the first surface.

In some embodiments, the first surface of the plate is dried with nitrogen after cleaning the first surface of the plate.

In some embodiments, applying the solvent to the first surface of the plate comprises pipetting the solvent onto the first surface.

In some embodiments, a ratio of a volume of solvent applied to the first surface of the plate to a surface area of the first surface of the plate is between 1 mL:300 mm² and 1 mL:600 mm². In some embodiments, a ratio of a volume of solvent applied to the first surface of the plate to a surface area of the first surface of the plate is between 1 mL:390 mm² and 1 mL:510 mm².

In some embodiments, the first surface of the plate is dried in ambient conditions after removing the master from contact with the plate.

In some embodiments, the master comprises a nanometer-scale patterned structure. In some embodiments, the master is a finger. In some embodiments, wherein pressing the finger against the first region of the plate after the first region of the plate has softened to thereby deform at least a portion of the first region into a negative mold comprises pressing and rolling the finger against the first surface of the plate after the first surface of the plate has softened.

Another aspect of the invention provides a method of nanocontact casting. The method may comprise providing a nanocontact mold fabricated according to a method described herein, introducing a silicone solution over the first surface of the plate, curing the silicone solution on the first surface of the plate at a curing temperature to make a cured silicone cast, and
removing the cured silicone cast from the first surface of the plate.

In some embodiments, the method comprises degassing the silicone solution after introducing the silicone solution over the first surface of the plate;

In some embodiments, the method comprises fabricating the silicone solution by mixing silicone precursors. In some embodiments, the silicone precursors comprise a silicone elastomer base and a silicone curing agent. In some embodiments, the method comprises fabricating the silicone solution by mixing the silicone elastomer base and the silicone curing agent in a ratio between 5:1 and 20:1. In some embodiments, the method comprises fabricating the silicone solution by mixing the silicone elastomer base and the silicone curing agent in a ratio of 10:1. In some embodiments, the method comprises fabricating the silicone solution by mixing the silicone precursors and colour pigment. In some embodiments, the method comprises fabricating the silicone solution by mixing the silicone precursors and conductive particles. In some embodiments, the conductive particles comprise silver coated aluminum nanoparticles. In some embodiments, the conductive particles comprise silver nanowires.

In some embodiments, the curing temperature is between 60° C. and 100° C. In some embodiments, the curing temperature is between 70° C. and 90° C. In some embodiments, the curing temperature is between 75° C. and 85° C. In some embodiments, the curing temperature is between 20° C. and 30° C.

In some embodiments, the method comprises curing the silicone solution on the first surface of the plate at the curing temperature for between 1 hour and 3 hours to make the cured silicone cast. In some embodiments, the method comprises curing the silicone solution on the first surface of the plate at the curing temperature for between 1.5 hour and 2.5 hours to make the cured silicone cast. In some embodiments, the method comprises curing the silicone solution on the first surface of the plate at the curing temperature for between 24 hour and 48 hours to make the cured silicone cast.

In some embodiments, the method comprises removing the cured silicone cast from the first surface of the plate comprises cutting and peeling the cured silicone cast from the first surface of the plate.

In some embodiments, the silicone solution comprises a polydimethylsiloxane (PDMS) solution.

In some embodiments, the cured silicone cast comprises a nanometer-scale patterned structure. In some embodiments, the cured silicone cast comprises a fingerprint phantom.

In some embodiments, the method comprises fabricating the silicone solution by mixing the silicone precursors by vortexing and or stirring.

Another aspect of the invention provides a method of using a fingerprint phantom. The method may comprise providing a fingerprint phantom fabricated according to a method described herein and wrapping the fingerprint phantom around a glove or a finger.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 schematically depicts an exemplary method of fabricating a mold according to one exemplary embodiment of the invention.

FIG. 2 schematically depicts an exemplary method of casting according to one exemplary embodiment of the invention.

FIG. 3A schematically depicts one step an exemplary method of fabricating a mold according to one exemplary embodiment of the invention. FIG. 3B schematically depicts a plate and its deformed surface after the step of FIG. 3A.

FIG. 4A is a photograph of a fingertip to be employed as a master. FIG. 4B depicts a mold comprising a fingerprint impression made from the FIG. 4A fingertip. FIG. 4C depicts a fingerprint phantom casted from the FIG. 4B mold.

FIG. 5A is a sample representation of a plurality of features of the fingerprint of the fingertip in FIG. 4A. FIG. 5B depicts the features of the FIG. 4B mold that correspond to the features of FIG. 5A. FIG. 5C depicts the features of the FIG. 4C fingerprint phantom that correspond to the features of FIG. 5A.

FIG. 6A is an optical image of an actual fingerprint obtained with a fingerprint scanner. FIG. 6B is an optical image of an exemplary fingerprint phantom obtained with a fingerprint scanner according to a particular embodiment. FIG. 6C is a binarized representation of the FIG. 6A fingerprint. FIG. 6D is a binarized representation of the FIG. 6B fingerprint phantom.

FIG. 7A is an optical image of an actual fingerprint obtained with a fingerprint scanner. FIG. 7B is an optical image of an exemplary fingerprint phantom obtained with a fingerprint scanner according to a particular embodiment. FIG. 7C is a binarized representation of the FIG. 7A fingerprint. FIG. 7D is a binarized representation of the FIG. 7B fingerprint phantom.

FIG. 8A is an optical image of an actual fingerprint obtained with a fingerprint scanner. FIG. 8B is an optical image of an exemplary fingerprint phantom obtained with a fingerprint scanner according to a particular embodiment. FIG. 8C is a binarized representation of the FIG. 8A fingerprint. FIG. 8D is a binarized representation of the FIG. 8D fingerprint phantom.

FIG. 9A shows an optical image of a fingerprint mold. FIG. 9B shows an optical image of an exemplary PDMS fingerprint phantom casted from the FIG. 9A fingerprint mold in accordance with a particular embodiment. FIGS. 9C, 9E and 9G show magnified images of the FIG. 9A fingerprint mold. FIGS. 9D, 9F and 9H show magnified images of the FIG. 9B fingerprint phantom.

FIGS. 10A and 10B are the results of imaging a polycarbonate mold with a profilometer. FIGS. 10C and 10D are the results of imaging an exemplary PDMS phantom with a profilometer.

FIG. 11A is a low magnification SEM image of an exemplary fingerprint negative mold in polycarbonate. FIG. 11B displays the same area of an exemplary PDMS phantom casted from the FIG. 11A polycarbonate mold. FIGS. 11C, 11E and 11G are magnified views of portions of the FIG. 11A fingerprint negative mold. FIGS. 11D, 11F and 11H are magnified view of portions of the FIG. 11B PDMS phantom.

FIG. 12A is an SEM image of an exemplary PDMS master fabricated from a DVD-R. FIG. 12B is an atomic force microscopy images of the FIG. 12A PDMS master. FIG. 12C depicts the vertical relief of the nanometer-scale diffraction grating of the FIG. 12A PDMS master.

FIG. 13A is an SEM image of an exemplary polycarbonate mold fabricated from the FIG. 12A PDMS master. FIG. 13B is an atomic force microscopy image of the FIG. 13A polycarbonate mold. FIG. 13C depicts the vertical relief of the FIG. 13A polycarbonate mold.

FIG. 14A is an SEM image of an exemplary PDMS cast fabricated from the FIG. 13A polycarbonate mold. FIG. 14B is an atomic force microscopy image of the FIG. 14A PDMS cast. FIG. 14C depicts the vertical relief of the FIG. 14A PDMS cast.

FIG. 15A, is a photograph of an untreated polycarbonate sample. FIG. 15B depicts the UV/Vis transmittance spectra of the FIG. 15A polycarbonate sample. FIG. 15C is a photograph of a treated polycarbonate sample. FIG. 15D depicts the UV/Vis transmittance spectra of the FIG. 15C polycarbonate sample. FIG. 15E is a photograph of a fingerprinted polycarbonate sample. FIG. 15F depicts the UV/Vis transmittance spectra of the FIG. 15E polycarbonate sample.

FIG. 16A is an exemplary fingerprint image obtained with a desktop scanner and a black background. FIGS. 16B, 16C and 16D are magnified views of the FIG. 16A fingerprint.

FIGS. 17A and 17C are the results of imaging an exemplary polycarbonate mold with a profilometer. FIG. 17B is a polarized optical microscopy image of the FIG. 17A fingerprint. The inset image of FIG. 17B is the same section as FIG. 17B, but illuminated at a different angle. FIG. 17D is a polarized optical microscopy image of unmodified polycarbonate.

FIG. 18A shows an exemplary fingerprint molded polycarbonate at low magnification. FIGS. 18B, 18C and 18D are magnified views of the FIG. 18A fingerprint molded polycarbonate. FIG. 18E schematically depicts a ridge impression and associated structural characteristics.

FIG. 19A is an optical image of an exemplary fingerprint mold made with a particular embodiment of the methods described herein. FIG. 19B is an image of a fingerprint (i.e. made from the same finger as FIG. 19A) made with a traditional paper inking method. FIG. 19C is an image of a fingerprint (i.e. made from the same finger as FIG. 19A) made with an optical fingerprint scanner.

FIG. 20A is an image of an exemplary polycarbonate master. FIG. 20B is an image of a PDMS cast made from the FIG. 20A master. FIG. 20C is a polycarbonate mold made from the FIG. 20B cast.

FIG. 21A is an image of an exemplary master. FIG. 21B is the result from imaging the FIG. 21A master with a profilometer. FIG. 21C is a representation of the profile of a portion of the FIG. 21A master.

FIG. 22A is an image of an exemplary PDMS cast. FIG. 22B is the result from imaging the FIG. 22A PDMS cast with a profilometer. FIG. 22C is a representation of the profile of a portion of the FIG. 22A PDMS cast.

FIG. 23A is an image of an exemplary polycarbonate mold. FIG. 23B is the result from imaging the FIG. 23A mold with a profilometer. FIG. 23C is a representation of the profile of a portion of the FIG. 23A mold.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides a method for fabricating a mold. The mold may comprise mold features with nanometer-scale resolution or minimum dimensions (e.g. the mold replicates nanometer-scale features of a master). The mold may comprise mold features with nanometer to micrometer-scale resolution or minimum dimensions (e.g. the mold replicates nanometer to micrometer-scale features of a master). The method may comprise providing a plate; applying a solvent to a first surface of the plate; allowing the solvent to penetrate from the first surface into the plate to thereby soften a first region of the plate, the first region of the plate including the first surface; pressing a master against the first region of the plate after the first region of the plate has softened to thereby deform at least a portion of the first region into a negative mold; and removing the master from contact with the plate. In some embodiments at least some solvent is removed from the first region of the plate.

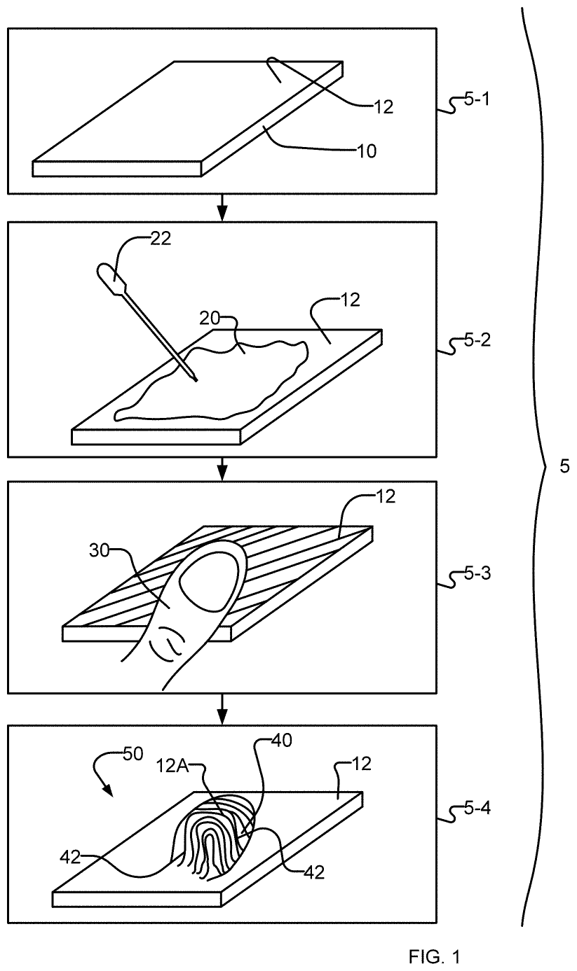

Blocks 5-1, 5-2, 5-3 and 5-4 of FIG. 1 illustrate one exemplary embodiment of a method 5 for fabricating a mold 50 from features 32 of a master 30 according to one example embodiment.

Block 5-1 depicts a plate 10 having a first surface 12. First surface 12 may comprise an entire planar surface of plate 10 or just a portion of a planar surface of plate 10 upon which it is desired to form a negative mold. Plate 10 may comprise, for example, a polycarbonate plate. For example, plate 10 may comprise a polycarbonate material such as Makrolon™, Lexan™ or Tuffak™. In some embodiments, plate 10 may comprise polystyrene or molding plastic such as Freeplastic™.

In some embodiments, first surface 12 may be planar. This is not mandatory. First surface 12 may be convex or concave. In some embodiments, a root mean square (RMS) roughness of first surface 12 may be less than 1 μm. In some embodiments, a root mean square (RMS) roughness of first surface 12 may be less than 10 nm.

In some embodiments, first surface 12 of plate 10 may be cleaned. For example, first surface 12 may be cleaned with ethanol and/or deionized water. In some embodiments, first surface 12 may be dried after cleaning to remove the cleaning substances (e.g. ethanol and/or deionized water). For example, in some embodiments, first surface 12 is dried (e.g. any remaining cleaning substances such as ethanol and/or deionized water are allowed to evaporate) in ambient conditions (e.g. 20-24° C. and 26-34% humidity). In other embodiments, first surface 12 is dried with nitrogen or other suitable gas.

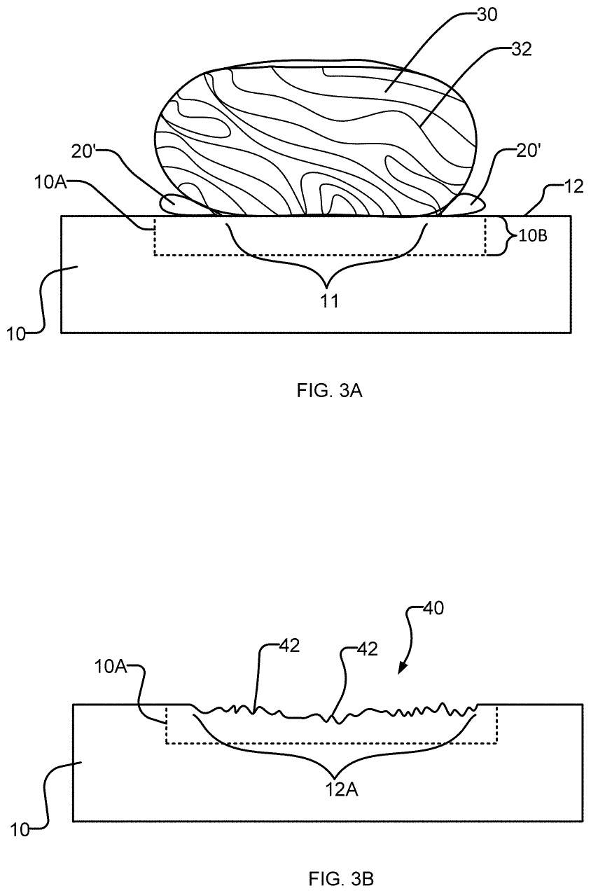

At block 5-2, a solvent 20 is applied to first surface 12. Solvent 20 may be allowed to penetrate from first surface 12 into plate 10 to thereby soften a region 10A of plate 10 (see FIG. 3A). Specifically, solvent 20 may penetrate into a polymer network in region 10A of plate 10, causing region 10A to soften and/or swell. Region 10A may include first surface 12.

Region 10A may have any desired depth 10B (see FIG. 3A) that is suitable for a corresponding application. In some embodiments, region 10A has a depth in the range of 15 μm to 45 μm. In some embodiments, region 10A has a depth in the range of 25 μm to 30 μm. Region 10B may have a threshold depth 10B that is correlated with and/or proportionate to the depth or height of features 32 to be molded into plate 10. For example, region 10A may have a depth 10B that is greater than a threshold of twice the depth or height of features 32 to be molded into plate 10. Region 10A may have a depth 10B that is greater than a threshold of five times the depth or height of features 32 to be molded into plate 10. In practice, some solvent 20 may penetrate deeper and/or wider than region 10A during method 5.

In some embodiments, solvent 20 is applied to first surface 12 after first surface 12 is cleaned and dried. Solvent 20 may be applied to first surface 12 by, for example, a pipette 22 or a spray bottle (not depicted). This is not mandatory. In some embodiments, solvent 20 is applied to first surface 12 by a spraying, by pouring, by automatic pipette, by misting, and/or by any other suitable technique.

Solvent 20 may comprise any suitable solvent. Solvent 20 may comprise a liquid at the temperature and pressure associated with the performance of method 5. In some embodiments, solvent 20 may comprise acetone or diluted acetone. In some embodiments, solvent 20 is at least 60% acetone (by weight). In some embodiments, solvent 20 is at least 95% acetone (by weight). In some embodiments, solvent 20 is at least 99% acetone (by weight). In some embodiments, solvent 20 is at least 99.8% acetone (by weight). In some embodiments, solvent 20 comprises ethyl acetate, acetonitrile, diluted hexane, diluted toluene, nail polish remover and/or the like.

In some embodiments, the volume of solvent 20 applied to first surface 12 may be correlated with and/or proportional to the surface area of first surface 12 and/or a desired volume of region 10A. For example, in some embodiments, a ratio of the volume of solvent 20 applied to first surface 12 of plate 10 to a surface area of first surface of plate 10 is between 1 mL:300 mm² and 1 mL:600 mm². In some embodiments, a ratio of the volume of solvent 20 applied to first surface 12 of plate 10 to a surface area of first surface of plate 10 is between 1 mL:390 mm² and 1 mL:510 mm².

The application of solvent in bock 5-2 softens the plate in region 10A of plate 10. In some embodiments, as discussed below, excess solvent may be removed from plate 10 after block 5-2 and prior to block 5-3. At block 5-3, master 30 is pressed against region 10A after region 10A is softened by the application of solvent 20 to thereby deform at least a portion of first region 10A into a negative mold having a deformed surface 12A. Master 30 may comprise any suitable master having any desired shape. For example, in some applications, it is desirable to create a mold of a fingerprint and master 30 is a fingertip (as depicted in block 5-3 of FIG. 1 and in FIG. 3A). This is not mandatory. Master 30 may comprise any desired object or shape. In some embodiments, master 30 comprises a surface having nanometer or micrometer scale features 32. In some embodiments, master 30 is fabricated by lithography (e.g. photolithography or electron beam lithography).

Master 30 may be pressed against region 10A with sufficient force or pressure to deform some of the softened material of region 10A. In some embodiments, master 30 is pressed against region 10A with a pressure of between 2 psi to 10 psi. In some embodiments, master 30 is pressed against region 10A with a pressure of between 3 psi to 7 psi. In some embodiments, master 30 is pressed against region 10A with a pressure of approximately 5 psi.

Swollen polymer chains of plate 10 may be rearranged by the application of force by master 30 to form a highly detailed (e.g. nanometer-scale or micrometer-scale resolution) negative mold 40 of master 30 (see FIG. 3B). Negative mold 40 may comprise a deformed surface 12A (FIG. 3B). In applications where master 30 is a finger, swollen polymer chains of plate 10 (e.g. of deformed surface 12A) may be rearranged between fingerprint ridges and into pores to form a highly detailed (e.g. nanometer-scale or micrometer-scale resolution) negative mold 40 of a fingerprint of the finger. Since, the swollen polycarbonate layer (e.g. region 10A) has a depth 10B that is greater than a depth of features 32 being molded (e.g. fingerprint ridges), minimal pressure applied to the swollen polycarbonate layer (e.g. region 10A) will cause region 10A (e.g. deformed surface 12A) to conform to features 32 of master 30. For example, both ridge width and depth can be recorded precisely by method 5, which would not be feasible in either paper inking or digital scanning protocols. In applications where master 30 is a finger, the finger may be rolled (e.g. from one edge of the finger nail to the other edge of the finger nail) while maintaining pressure to provide a negative mold 40 of the entire fingerprint.

Block 5-4 depicts a negative mold 40 and its deformed surface 12A on first surface 12 of plate 10. Negative mold 40 and its deformed surface 12A are formed by pressing master 30 against region 10A. After master 30 is removed from first surface 12 of plate 10, plate 10 may be allowed to dry further (e.g. remaining solvent 20 may be allowed to evaporate). In some embodiments, first surface 12 is allowed to dry in ambient conditions.

Negative mold 40 and its deformed surface 12A comprise a plurality of mold features 42. Mold features 42 may correspond to (e.g. be complementary to) features 32 of master 30. For example, in the case of a master 30 comprising a fingertip, mold features 42 may correspond to (e.g. be complementary to) ridges and pores of the fingertip. In some embodiments, mold features 42 may have micrometer-scale minimum dimensions. For example, mold features 42 may have dimensions in the range of 20-40 μm. In some embodiments, mold features 42 may have nanometer-scale minimum dimensions. For example, mold features 42 may have dimensions in the range of 125-300 nm.

Mold-fabrication method 5 may comprise removing at least some of solvent 20 (e.g. at least a portion of the applied solvent 20) from region 10A.

Removing at least some of solvent 20 from region 10A may comprise removing only a portion of the volume of solvent 20 applied at block 5-2. In some embodiments, 50% of solvent 20 applied at block 5-2 is removed from region 10A. In some embodiments, 70% of solvent 20 applied at block 5-2 is removed from region 10A. In some embodiments, 90% of solvent 20 applied at block 5-2 is removed from region 10A. In some embodiments, removing solvent 20 from region 10A comprises removing solvent 20 from first surface 12. In some embodiments, some amount of solvent 20 may remain in region 10A after removing solvent 20 from first surface 12.

In some embodiments, at least some of solvent 20 is removed from region 10A before master 30 is pressed against first surface 12 of region 10A (e.g. in between blocks 5-2 and 5-3). In some embodiments, at least some of solvent 20 is removed from region 10A while master 30 is pressed against first surface 12 (e.g. during block 5-3). In some embodiments, at least some of solvent 20 is removed from region 10A by master 30 being pressed against first surface 12. In some embodiments, at least some of solvent 20 is removed from region 10A after master 30 is pressed against first surface 12 (e.g. after block 5-3).

In some embodiments, at least some of solvent 20 is removed from region 10A within between 4 seconds and 120 seconds after the block 5-2 application of solvent 20. In some embodiments, at least some of solvent 20 is removed from region 10A within between 40 seconds and 60 seconds after the block 5-2 application of solvent 20. In some embodiments, at least some of solvent 20 is removed from region 10A within between 4 seconds and 12 seconds after the block 5-2 application of solvent 20.

In some embodiments, the length of time before at least a portion of solvent 20 is removed from region 10A is dependent on the resolution of features 32 of the master 30. For example, for masters 30 having nanometer-scale features 32, the period of time before at least a portion of solvent 20 is removed from region 10A may between 4 and 16 seconds while for masters having micrometer-scale features 32, the period of time before at least a portion of solvent 20 is removed from region 10A may be between 20 and 40 seconds.

In some embodiments, the length of time before solvent 20 is removed from first surface 12 is dependent on the time for crystallization (e.g. formation of spherulites) of the material of region 10A (e.g. polycarbonate) to occur. For example, in some embodiments, it is desirable to remove solvent 20 from first surface 12 before crystallization occurs or before substantial crystallization occurs. For example, where masters 30 have nanometer-scale features 32, crystallization may have a negative effect on the resultant mold given that surface features of a spherulite may be on the scale of 200-400 nm and spherulites themselves may be on the scale of 3-8 μm. Therefore it may be desirable to remove solvent 20 from first surface 12 before crystallization occurs. In contrast, for a fingerprint mold where features 32 of the master (e.g. fingerprint) are on the scale of 20-40 μm (e.g. pores of the fingerprint) or 200-500 μm (e.g. ridges of the fingerprint), crystallization may have a less severe negative impact on the resultant mold and it may be acceptable (although not necessarily desirable) for some crystallization to occur. As such, where features 32 of master 30 are on the micrometer scale, it may be acceptable for solvent 20 to remain in contact with first surface 12 for a longer period of time.

In some embodiments, the length of time before at least some of solvent 20 is removed from region 10A is dependent on the desired depth 10B of region 10A. In some embodiments, the length of time before at least some of solvent 20 is removed from region 10A is dependent on the composition of solvent 20. In some embodiments, the length of time before at least some of solvent 20 is removed from region 10A is dependent on the porosity and/or composition of region 10A.

Solvent 20 may be removed from region 10A and/or first surface 12 by any suitable technique. In some embodiments, solvent 20 is removed from region 10A and/or first surface 12 by evaporation (which may comprise passive removal of solvent 20). In some embodiments, solvent 20 is removed from first surface 12 by blowing it off with air or nitrogen. In some embodiments, solvent 20 is removed from region 10A and/or first surface 12 by the application of pressure by a master 30 which pushes solvent 20 away. In some embodiments, solvent 20 is removed from region 10A and/or first surface 12 by a combination of any two or more of evaporation, blowing and pressure.

In some embodiments, by pressing master 30 against region 10A, solvent 20 is pushed away from a contact portion 11 of region 10A that is in contact with master 30, as depicted in FIG. 3A. In some embodiments, master 30 may be pressed against region 10A until all visible solvent 20′ (e.g. the solvent 20 that is pushed away from the contact portion 11 of region 10A) is evaporated or otherwise removed. When master 30 is removed from contact with plate 10, the contact portion 11 of region 10A may become deformed surface 12A. Because of the removal of visible solvent 20′ from contact region 11 during the application of force/pressure by master 30 on plate 10, the likelihood of remaining solvent 20 undesirably moving into contact with deformed surface 12A when master 30 is removed may be minimized. This may prevent or reduce undesirable prolonged contact of solvent 20 with deformed surface 12A which may thereby prevent or reduce undesirable crystallization.

Another aspect of the invention provides a method for casting. The method may comprise providing a mold according to any of the methods described herein (e.g. method 5), introducing (e.g. pouring or the like) a silicone solution over the mold (e.g. over first surface 12 of plate 10); curing the silicone solution on the mold at a curing temperature to make a cured silicone cast; and removing the cured silicone cast from the mold.

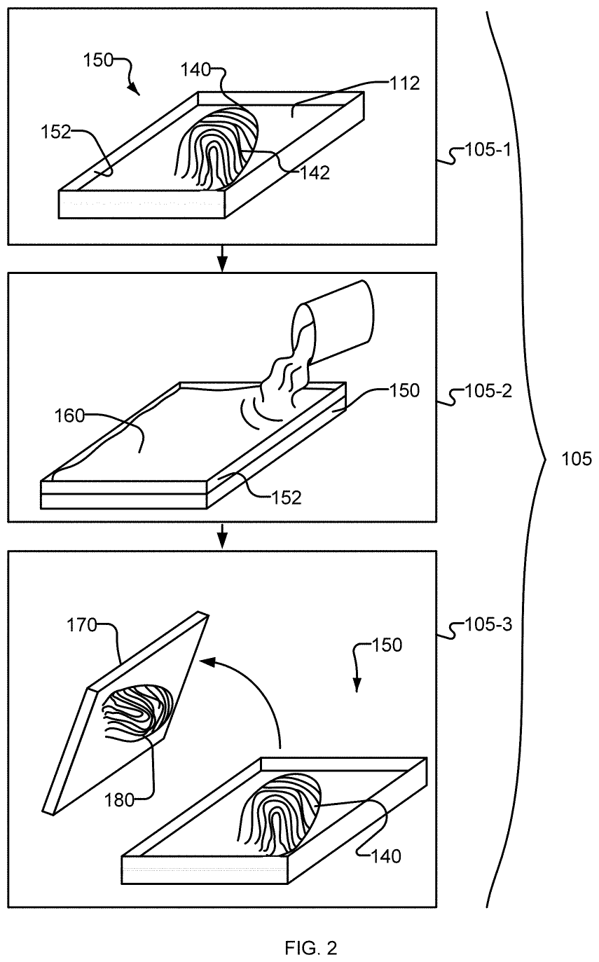

Blocks 105-1, 105-2 and 105-3 of FIG. 2 illustrate one exemplary embodiment of a method 105 for casting according to one example embodiment.

At block 105-1, a mold 150 having a negative mold 140 of a master 130 is provided. Mold 150 may be any suitable mold. For example, mold 150 may comprise nanometer-scaled resolution (e.g. the mold may have mold features 142 having nanometer-scale minimum dimensions). Mold 150 may be similar to mold 50 or may comprise mold 50 fabricated according to method 5 described herein.

Block 105-2 depicts a silicone solution 160 being introduced (e.g. poured or the like) over negative mold 140 on first surface 112 of mold 150. In some embodiments, silicone solution 160 comprises polydimethylsiloxone (PDMS). Silicone solution 160 may comprise a mixture of silicone precursors such as, for example, a silicone elastomer base and a silicone curing agent. In some embodiments, silicone solution 160 may be fabricated by mixing the silicone elastomer base and the silicone curing agent in a ratio of between 5:1 and 20:1 (by weight). In some embodiments, silicone solution 160 may be fabricated by mixing the silicone elastomer base and the silicone curing agent in a ratio of 10:1 (by weight). In some embodiments, the silicone precursors are mixed by stirring and/or vortexing.

Fingerprint scanners rely on various techniques for detecting ridges (optical, conductivity, ultrasound, thermal) and may use additional measures to verify the authenticity of fingerprints. For use with ultrasound based scanners, silicone (e.g. PDMS) may itself be suitable for a cast, as silicone (e.g. PDMS) possesses a similar density to human tissue. However, while silicone (e.g. PDMS) may be a sufficient physical analog of skin in terms of strength and elasticity, it may be that optical and electrical properties of silicone (e.g. PDMS) are different than those of skin, which can lead to unreadable phantoms for certain types of scanners.

In some embodiments, silicone solution 160 comprises PDMS mixed with one or more additives. Such additives may impart an eventual silicone cast 170 with desired features (e.g. optical and electrical properties). For example, to approximate optical properties of human tissue, a flesh colored silicone pigment (e.g. pantone 488C) may be added at low weight percent (e.g. less than 10% by weight in some embodiments; less than 5% by weight in some embodiments; about 3% by weight in some embodiments; less than 2% by weight in some embodiments) to silicone solution 160. Pigmentation may provide better scattering and absorption for optical scanners to resolve ridges clearly. Many different pigments can be chosen or combined to mimic a wide range of skin tones.

In some embodiments, silicone solution 160 may comprise, for example, one or more conductive PDMS precursors (e.g. to produce an electrically conductive fingerprint phantom). In some embodiments, silicone solution 160 may comprise silver coated aluminum nanoparticles dispersed at their percolation threshold. In some embodiments, greater than 15% (by weight) silver nanowires and particles is provided in silicone solution 160. In some embodiments, greater than 18% (by weight) silver nanowires and particles in is provided in silicone solution 160. In some embodiments, greater than 20% (by weight) silver nanowires and particles in PDMS is provided in silicone solution 160. Commercially available conductive PDMS precursors with silver coated aluminum nanoparticles may also be employed. It is desirable for such phantoms to achieve an electrical resistance of ˜16 MΩ/cm+/−10% to properly simulate human tissue. There is a degree of flexibility in achieving readability by capacitive scanners because they are built to detect fingers with a high rate of success by accepting large variations in conductivity.

Silicone thinner may be added at between 2-7% by weight (e.g. 5% by weight) to decrease viscosity and ensure complete molding of fingerprints impressions.

In some embodiments, silicone solution 160 comprises polyurethane, Ecoflex™, or another suitable polymer or elastomer. In some embodiments, silicone solution 160 comprises a PDMS solution purchased from Sylgard™. Silicone solution 160 may be chosen to have a sufficiently low viscosity for silicone solution 160 to completely fill mold 150 and ensure complete molding. In some embodiments, lower viscosity silicone solution 160 is used where mold 150 has smaller (e.g. nanometer-scale) features as compared to when mold 150 has larger (e.g. micrometer-scale) features.

In some embodiments, mold walls 152 may be provided to contain silicone solution 160 as it is introduced atop mold 150. Mold walls 152 may form a perimeter around first surface 112 or around negative mold 140.

After silicone solution 160 is introduced over negative mold 140 and/or first surface 112, silicone solution 160 may optionally be degassed to remove any dissolved gases from silicone solution 160. Any suitable degassing technique may be employed. For example, silicone solution 160 may be placed under reduced pressure. In some embodiments, membrane degasification, sparging by inert gas, addition of a reductant, freeze-pump-thaw cycling and/or any other suitable degassing technique may be employed.

After silicone solution 160 is introduced over negative mold 140 and/or first surface 112 and after optional degassing of silicone solution 160, silicone solution 160 may be cured on negative mold 140 at a curing temperature to form a cured silicone cast 170. In some embodiments, curing time and curing temperature are dependent on the composition of silicone solution 160. In some embodiments, the curing temperature is between 60° C. and 100° C. In some embodiments, the curing temperature is between 75° C. and 85° C. In some embodiments, silicone solution 160 is cured on first surface 112 and/or negative mold 140 at the curing temperature for between 1 hour and 3 hours to make cured silicone cast 170. In some embodiments, silicone solution 160 is cured on first surface 112 and/or negative mold 140 at the curing temperature for between 1.5 hour and 2.5 hours to make cured silicone cast 170. In some embodiments the curing time is dependent on the temperature. For example, as the curing temperature increases, the curing time may decrease and as the curing temperature decreases, the curing time may increase. In some embodiments, the curing temperature is at or near ambient temperature (e.g. between 20° C. to 30° C.) and the curing time is between 24 hours and 48 hours.

At block 105-3, after silicone solution 160 is sufficiently cured and cured silicone cast 170 is formed, cured silicone cast 170 may be removed from mold 150. In some embodiments, cured silicone cast 170 is removed by cutting and/or peeling. In some embodiments, mold 150 remains substantially intact after silicone cast 170 is removed from mold 150 and mold 150 may be re-used.

In some embodiments, such as where master 30 is a finger, silicone cast 170 may be a fingerprint phantom. In some embodiments, the fingerprint phantom may be wrapped around a finger of a glove or an actual finger to give the fingerprint phantom a desired shape.

### Experimental Results

The inventors conducted various experiments to evaluate method 5 and method 105. In some experiments, a 1.5 inch by 1.5 inch piece of polycarbonate (e.g. plate 10) was cut from a large sheet and the protective film removed from one side. The polycarbonate surface (e.g. first surface 12) was washed with deionized water and ethanol and then dried with nitrogen. 1.0 mL of acetone (e.g. solvent 20) was dispensed onto the polycarbonate surface (e.g. first surface 12) with an automatic pipette and left for 45 seconds. A finger (e.g. master 30) was then either pressed with mild force or rolled to produce a fingerprint impression (e.g. negative mold 40) on the surface. The polycarbonate plate was left to dry (e.g. any remaining solvent 20 was allowed to evaporate) in ambient conditions to solidify the fingerprint impression and form a mold (e.g. mold 50, 150).

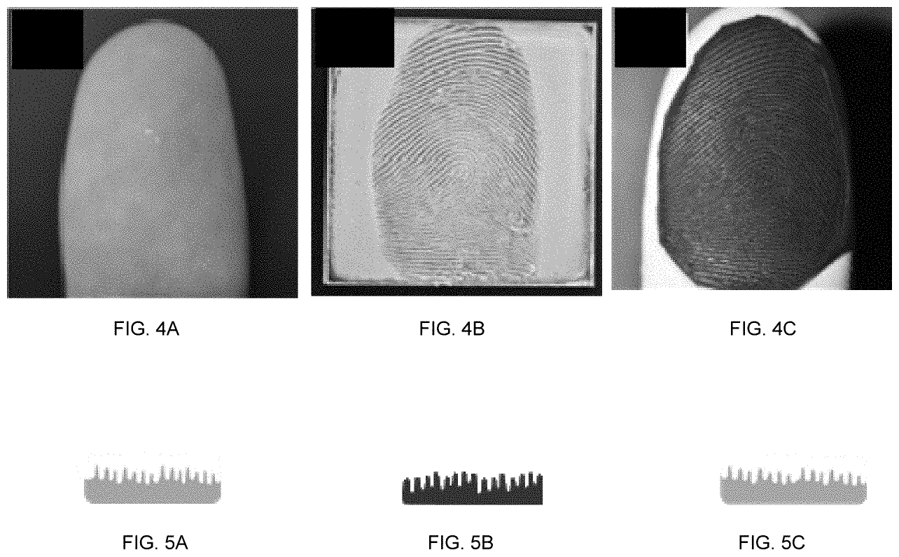

Fingerprint phantoms (e.g. casts 170) were constructed by casting PDMS using the polycarbonate mold (e.g. mold 150) according to method 105. Two precursors to PDMS: an elastomer base (part A) and a curing agent (part B) were mixed in a 10:1 ratio (by weight) by manual stirring and vortexing. The precursor solution (e.g. silicone solution 160) was poured over the polycarbonate mold 150, degassed for 45 minutes in a vacuum chamber, and then cured in an oven at 80° C. for 2 hours. The PDMS phantom was then cut and peeled from the mold. FIGS. 4A to 4C are photographs taken at various steps of this procedure.

Specifically, FIG. 4A is a photograph of a fingertip employed as a master 30. FIG. 4B depicts a mold (e.g. mold 50, 150) comprising a fingerprint impression (e.g. negative mold 40) on a polycarbonate plate 10 made from the FIG. 4A fingertip according to method 5. FIG. 4C depicts a PDMS fingerprint phantom (e.g. cast 170) cast from the FIG. 4B mold according to method 105. The FIG. 4C fingerprint phantom was constructed in 2-3 hours without using any sophisticated and/or expensive tools. Inexpensive polycarbonate plates and commercially available PDMS kits were employed for the experiment depicted in FIGS. 4A to 4C.

FIG. 5A is a representation of a plurality of features (e.g. features 32) of the fingerprint in FIG. 4A. FIG. 5B is a representation of the features (e.g. mold features 42) of the FIG. 4B mold of that correspond to the FIG. 5A features. FIG. 5C is a representation of the features of the FIG. 4C PDMS fingerprint phantom that correspond to the FIG. 5A features. As can be seen by comparing FIG. 5B to FIG. 5A, the features of the FIG. 4A fingerprint were closely replicated on the FIG. 4B mold. As can be seen by comparing FIG. 5C to FIG. 5B the features of the FIG. 4B mold were closely replicated on the FIG. 4C PDMS fingerprint phantom. As can be seen by comparing FIG. 5C to FIG. 5A, the features of the FIG. 4A fingerprint, were closely replicated on the FIG. 4C PDMS fingerprint phantom.

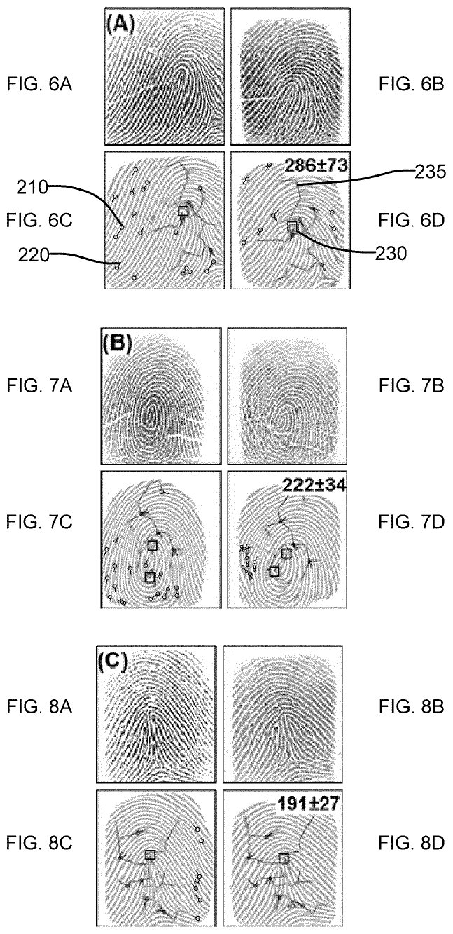

The quality of various PDMS fingerprint phantoms made using method 5 and 105 was first examined for fidelity with the original fingerprints (e.g. masters 30) from which they were made. FIGS. 6A to 6D, 7A to 7D and 8A to 8D are representative of the three most popular fingerprint classes (based on the core). FIGS. 6A to 6D are representative of a loop. Loops are present in approximately 65% of the population's fingerprints. FIGS. 7A to 7D are representative of a whorl. Whorls are present in approximately 30% of the population's fingerprints. FIGS. 7A to 7D are representative of an arch. Arches are present in approximately 5% of the population's fingerprints. FIGS. 6A, 7A and 8A are optical images of actual fingerprints. FIGS. 6B, 7B and 8B are optical images of fingerprint phantoms made using methods 5 and 105. FIGS. 6A to 6B, 7A to 7B and 8A to 8B were collected with the Secugen™ Hamster Plus digital fingerprint scanner. FIGS. 6C, 7C and 8C are binarized representations of the fingerprints shown in FIGS. 6A, 7A and 8A respectively. FIGS. 6D, 7D and 8D are binarized representations of the fingerprint phantoms shown in FIGS. 6B, 7B and 8B respectively. Similarity scores which rate the similarity between the binarized representations of the fingerprints shown in FIGS. 6A, 7A and 8A and the binarized representations of the fingerprint phantoms shown in FIGS. 6B, 7B and 8B are displayed on in the top right corners of FIGS. 6D, 7D and 8D.

As can be seen by comparing FIG. 6A to FIG. 6B, FIG. 7A to FIG. 7B and FIG. 8A to FIG. 8B, the fingerprint phantom optical images are practically indistinguishable from the original fingerprints (e.g. the position and size of ridges match). As can be seen in FIG. 6B, FIG. 7B and FIG. 8B, the dimensions of the ridges of the fingerprint phantoms are clearly defined. The subtleties in ridge width and height of the fingerprint phantoms are recorded by the scanner and details such as pores and ridge contours to stand out. Such distinct features may aid in optimizing scanners for imaging real fingerprints. In contrast, artificially designed fingerprint ridges, such as those produced by three-dimensional printing of fingerprint phantoms, do not include variation in ridge width and depth that naturally occur.

In the binarized representations (e.g. FIGS. 6C and 6D, FIGS. 7C and 7D and FIGS. 8C and 8D), anywhere that the fingerprint matching software (Verifinger SDK) detects a ridge, it is represented as solid color on a white background. These binarized representations allow the software to match fingerprints readily based on the location of minutiae (e.g. unique fingerprint ridge arrangements). Like real fingerprints, phantom fingerprints made using methods 5, 105 can be accurately converted to a binarized representation. As can be seen from comparing FIG. 6C to FIG. 6D, FIG. 7C to FIG. 7D and FIG. 8C to FIG. 8D, the locations of binarized ridges of the fingerprint phantom are consistent with the locations of binarized ridges of the actual finger, indicating that real ridges and phantom ridges are interpreted consistently by the scanner.

Several fingerprint matching algorithms are currently available which operate on the principle of comparing fingerprint minutiae. Particularly, the software identifies the location and direction of minutiae (e.g. ridge ends or splits) and compares them. The output is a similarity score (see the top right corner of each of FIGS. 6D, 7D and 8D). Circles 210 overlaying the binarized fingerprint representations represent minutiae identified by the software. Vectors 220 protruding from circles 210 identify the direction of minutiae. Boxes 230 identify the location(s) of the core origins. Minutiae that match (based on direction and location relative to the core) between the original and phantom fingerprints are connected with lines 235 to form a “tree”. Differences in the distance between matched minutiae and the number of matches contribute to similarity scores. The scores displayed in FIGS. 6D, 7D and 8D are averages from three fingerprint phantoms of each source fingerprint. According to the specifications of Verifinger, a similarity score of 33 represents a false acceptance rate of 0.01%, which is considered sufficient for fingerprint matching. The similarity score for all phantoms depicted in FIGS. 6B, 7B and 8B are well above this matching threshold (e.g. greater than 190), indicating that the ridges are faithfully copied and detectable when imaged by a standard optical fingerprint scanner. These similarity scores indicate a less than 1/1,000,000 false acceptance rate. As such, PDMS fingerprint phantoms fabricated using methods 5 and 105 may fulfill the purpose of testing performance of fingerprint scanners and testing the fingerprint matching algorithms.

The quality of phantoms (e.g. casts 170) fabricated using methods 5 and 105 was further validated based on the reproduction (from master to mold and from mold to cast/phantom) of three different levels of physical details that exist within a fingerprint pattern. The first level of details is the location and arrangement of fingerprint ridges in relation to each other. The second level details (also referred to as minutiae) are unique ridge formations (e.g. patterns) formed where ridges come together and differentiate. The third level of details may comprise dimensional attributes of fingerprint ridges, including the width, edge contours, shape, location and size of pore and other permanent details such as creases or scars. Highly distinctive third level features are an excellent source of information for examining partial prints. In some circumstances, as few as 20-40 pores (e.g. the size and location of 20-40 pores) of a fingerprint are adequate for positive identification.

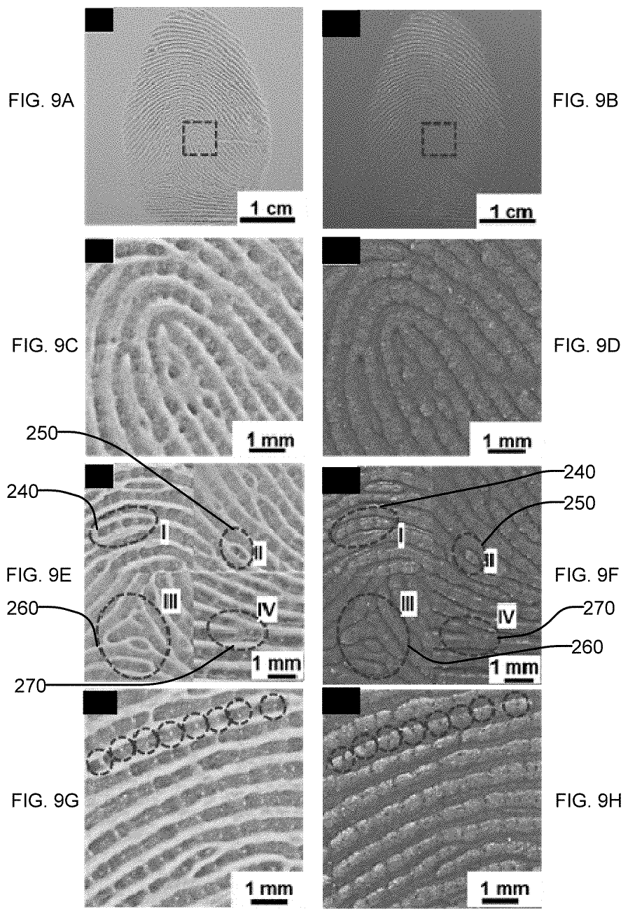

FIG. 9A shows an optical image of a fingerprint mold (e.g. a negative mold 40, 140). FIG. 9B shows an optical image of a PDMS fingerprint phantom casted from the FIG. 9A fingerprint mold using method 105. First level details are discernible in FIGS. 9A and 9B. FIGS. 9C, 9E and 9G show magnified images of the fingerprint core, selected second level details and selected third level details, respectively, of the FIG. 9A fingerprint mold. FIGS. 9D, 9F and 9H show magnified images of the fingerprint core, selected second level details and selected third level details, respectively, of the FIG. 9B PDMS fingerprint phantom. The regions depicted in FIGS. 9D, 9F and 9H correspond to the regions depicted in FIGS. 9C, 9E and 9G.

FIGS. 9C and 9D highlight the fingerprint core in the polycarbonate mold and PDMS phantom respectively. The fingerprint core may be used to align fingerprints for matching. In FIGS. 9E and 9F, several second level details are clearly defined. For example, FIGS. 9E and 9F show a bifurcation 240, a delta 250, a lake 260, and an incipient ridge 270. Comparison of the first level details discernible in FIGS. 9A and 9B and the second level details discernible in FIGS. 9C and 9D between the mold and the fingerprint phantom illustrates the accuracy of method 105. Specifically, minutiae recorded in the mold are present in the fingerprint phantom and their relative locations are consistent.

In general, the minimal size and depth of third level details such as sweat pores can make third level details difficult to identify and define. Third level features, however, can be accurately recorded in the polycarbonate mold using method 5 and reproduced in PDMS fingerprint phantoms using method 105, as best shown by comparing FIGS. 9G and 9H. A series of pores are highlighted in circles along a ridge in FIGS. 9G and 9H. By studying FIGS. 9G and 9H, it can be seen that other third level details such as ridge width and contours are also well replicated.

The inventors undertook experiments to determine what solvents could be employed as solvent 20 in method 5. Ethyl acetate was tested and was found to effectively swell and soften polycarbonate. However, it was found that polycarbonate hardens quickly after softening. Ethanol was also test. However, ethanol was found not to effectively swell and soften polycarbonate. Finally, while nail polish remover was successfully employed to fabricate a fingerprint mold, the resolution of the fingerprint mold was not ideal.

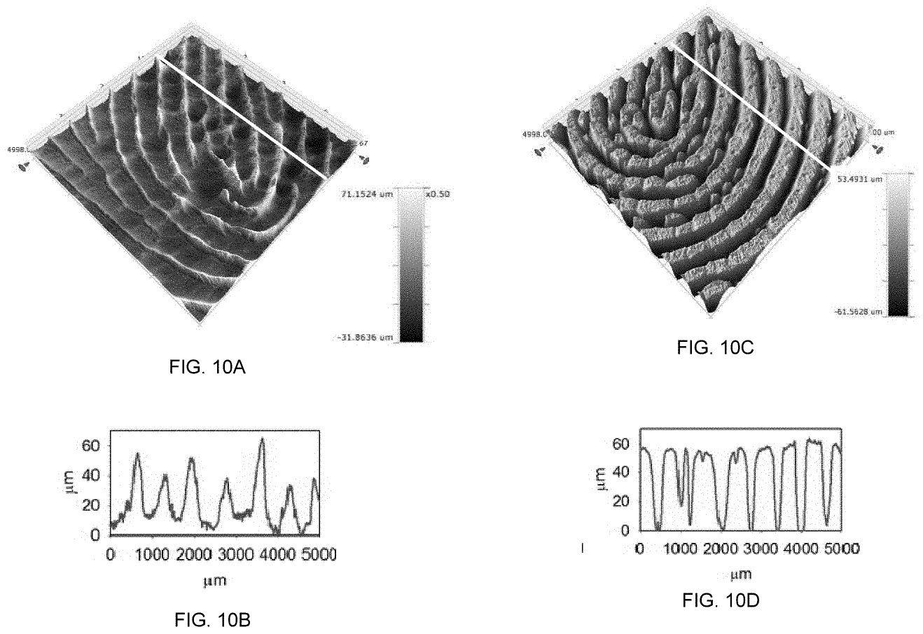

The inventors undertook experiments to study the capability of recording the depth of fingerprint ridges on a polycarbonate mold (e.g. mold 50) fabricated using method 5 (see FIGS. 10A and 10B) and reproducing them onto a PDMS phantom (e.g. cast 170) fabricated using method 105 (see FIGS. 10C and 10D). To study this characteristic, both the fingerprint polycarbonate mold and PDMS fingerprint phantom were imaged with a profilometer to examine the three-dimensional morphology (see FIGS. 10A-10D). For the particular fingerprint replicated, the average ridge width was between 500 and 700 μm and the height ranged from 40 to 60 μm, which is well within the range of ridge dimensions of typical human fingerprints.

Along the ridges of the polycarbonate mold (see FIG. 10A), small changes in depth are visible. The peaks corresponding to the space between ridges in the original fingerprint have more obvious variability in height (as shown in FIG. 10B). The PDMS phantom effectively copies the ridge impressions to reproduce subtle minutiae of original ridges. FIG. 10C shows that the ridges were reproduced down to the third level of fingerprint detail. Differences in the steepness of ridges and the depth of valleys between them can be differentiated in FIG. 10C. Along ridges, variations in height manifest as pore impressions and undulations in finger tissue. Subtleties such as the angle of ridge edges, partially developed ridges and shallow ridges were also well duplicated. The cross-section profile (see FIG. 10D) shows an incipient ridge located at 1200 μm and two pores located at 1600 μm, and 2300 μm, respectively, highlighting the reproduced micrometer-scale details. Three-dimensional recording of third level details in fingerprint phantoms fabricated with methods 5 and 105 confirms that the topography of the polycarbonate mold fabricated using methods 5 and 105 was effectively transferred to the PDMS phantom. These PDMS phantoms have the advantage over other two-dimensional image-derived phantoms because of their well-defined three-dimensional morphological information, which allows for proper fingerprint reading in sensor development and accuracy testing.

Polycarbonate fingerprint molds fabricated using method 5 described herein and PDMS phantoms fabricated using method 105 described herein were imaged with a scanning electron microscope (SEM) to study microstructural details and examine how such microstructural details are transferred during molding method 5 and casting method 105.

When swollen with a solvent 20 (e.g. acetone), polycarbonate not only forms a malleable surface, but also undergoes rearrangement at the molecular level. Solvent molecules penetrate between polymer chains, which push them apart and increase their free volumes. Greater free volumes allow polycarbonate which originally existed in an amorphous state (polymer chains are too rigid to crystallize from melt) to adopt ordered configurations and crystallize into spherulites (e.g. spherical semi-crystalline regions inside non-branched linear polymers). Spherulites in polycarbonate range in size between 5-10 μm in size. Spherulites comprise ˜100 nm crystalline polycarbonate tendrils which grow and branch outward from a central nucleation point with amorphous polycarbonate filling space between the tendrils. Evidence of polycarbonate spherulite impressions in PDMS would indicate that PDMS can mold features at least as small as spherulites or their tendrils (at micrometer and nanometer-scale, respectively).

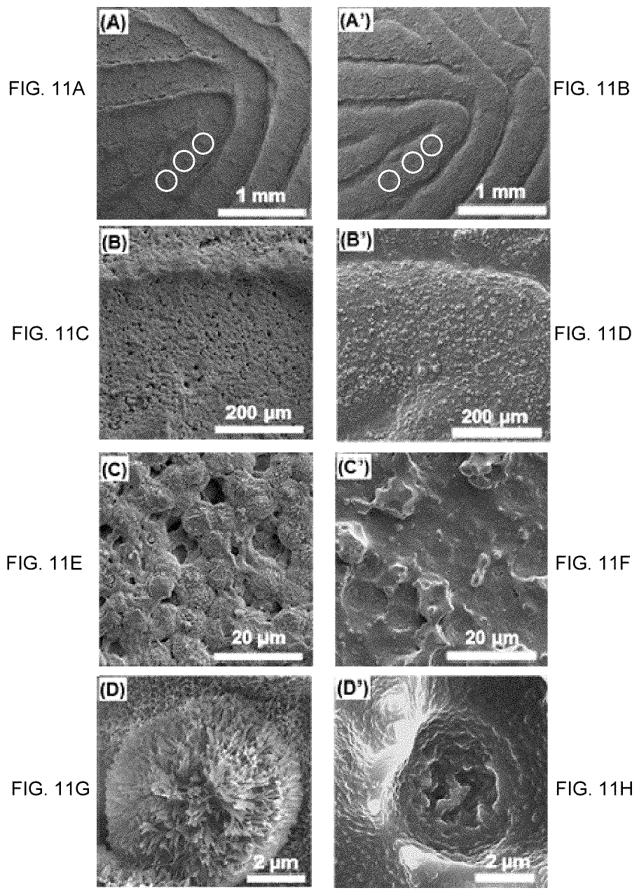

FIG. 11A is a low magnification SEM image of a fingerprint negative mold in polycarbonate (e.g. a negative mold 40). The fingerprint ridges in FIG. 11A are well defined. Raised sections along the fingerprint ridges in FIG. 11A corresponding to pores are visible, as is variation in ridge contours. FIG. 11B displays the same area of a PDMS phantom cast from the polycarbonate mold in FIG. 11A. Ridges of the PDMS phantom match the polycarbonate impressions. The sweat pores of the FIG. 11A fingerprint negative mold can be identified as slight depressions along the ridge of the fingerprint phantom. Further examination of ridge impressions seen in FIG. 11C reveal that the polycarbonate material forms a porous surface, as the polycarbonate chains rearrange into spherulites after swelling with acetone. The entire phantom surface is covered with uniformly distributed “protrusions” (see FIG. 11D), which conform to the porous surface of the polycarbonate mold. As shown in FIG. 11E, polycarbonate spherulites have rough surfaces and are interconnected with each other. Their sizes vary from 5 μm to 10 μm. These high magnification SEM images show that the PDMS phantom displays microscopic features as small as the spherulites from the polycarbonate (see FIG. 11F) with high fidelity.

The inventors observed that the shape of an individual spherulite can be cast on the PDMS phantom with the details corresponding to protruding tendrils using method 105. For example, see FIG. 11G which shows a polycarbonate spherulite and FIG. 11H which shows a PDMS impression of the FIG. 11G polycarbonate spherulite. The surface of spherulite impressions on the PDMS phantom shown in FIG. 11G are rough at the nanometer-scale as a result of PDMS conforming to the surface of spherulites formed on the polycarbonate mold. These SEM studies illustrate that methods 5, 105 to create fingerprint phantoms accurately replicate both the microscale and nanometer-scale details of the initial fingerprint.

Methods 5 and 105 for molding and casting have applications beyond fingerprint phantoms. For example, methods 5 and 105 can be applied to mold and cast microstructures and nanostructures. Traditional micro/nanofabrication techniques require costly materials (e.g. high-grade silicon wafers, photoresists) and equipment (e.g. electron beam or UV lithography facilities) and previous molding techniques require well controlled molding parameters and conditions. For example, many prior art molding methods require a heated compression molding press to supply consistent heating and/or pressure. In contrast, molds described herein can be fabricated from an unmodified sheet of polycarbonate rapidly under ambient laboratory conditions on a benchtop by method 5.

In one exemplary experiment, a DVD-R was delaminated by wedging a razor blade between the middle layers and separating them manually to expose the polycarbonate base with the data layer atop, which contains a nanometer-scale periodic diffraction grating (e.g. a pattern with a series of repeating ridges with a periodic width of 740 nm). The data (dye) layer was removed from the polycarbonate base by sonicating and washing with ethanol. A 1.5 inch by 1.5 inch piece of the polycarbonate base adorned with the diffraction grating was used to prepare a PDMS master for testing molding and casting according to method 5 and method 105.

To replicate the PDMS master made from the DVD-R grating, a 1.5 inch by 1.5 inch piece of polycarbonate (e.g. plate 10) was cut from a large sheet and the protective film removed from one side. The polycarbonate surface was washed with deionized water and ethanol and then dried with nitrogen. 1.0 mL of acetone was dispensed onto the polycarbonate surface with an automatic pipette and left for 10 seconds. Excess acetone was removed from the polycarbonate surface by holding it upside down after the 10 seconds acetone treatment. The polycarbonate substrate was placed onto and gently pressed into the PDMS master. After allowing it to dry for 10 minutes the polycarbonate was removed from the PDMS master. The polycarbonate plate was left to dry in ambient conditions to solidify the fingerprint impression and form a mold (e.g. mold 50, 150).

Casts (e.g. casts 170) were made using the polycarbonate mold. Two precursors to PDMS: an elastomer base (part A) and a curing agent (part B) were mixed in a 10:1 ratio (by weight) by manual stirring and vortexing. The precursor solution (e.g. silicone solution 160) was poured over the polycarbonate mold, degassed for 45 minutes in a vacuum chamber, and then cured in an oven at 80° C. for 2 hours. The PDMS cast was then cut and peeled from the mold.

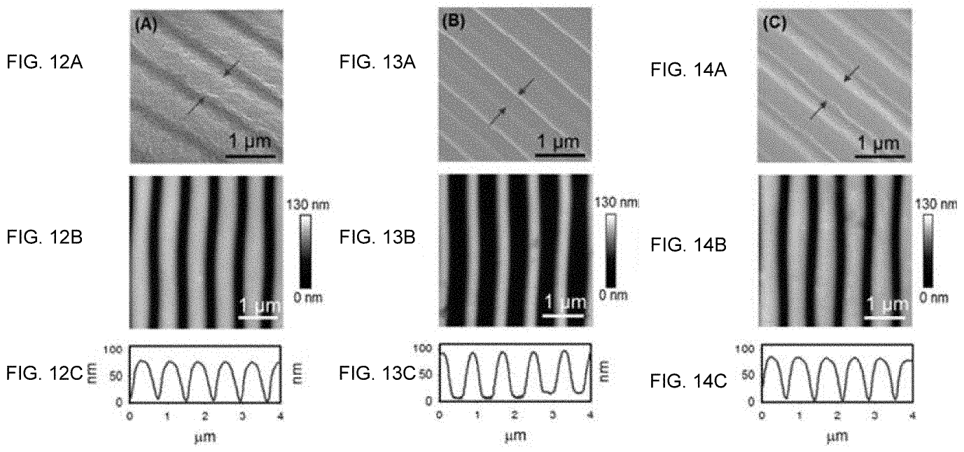

As shown in FIGS. 12A to 12C, the PDMS master prepared from the DVD-R substrate shows the expected nanometer-scale features, e.g. the width of the valleys (245±10 nm) and hills (480±25 nm) are consistent with the original DVD-R base. When the nanograting is molded into a polycarbonate plate from the PDMS template, the feature dimensions are consistent and well defined (see FIGS. 13A to 13C). The dimensions of peaks (320±20 nm) and valleys (465±30 nm) on the polycarbonate mold are uniform across areas as large as a few cm². Significant crystallization (formation of spherulites) was not observed on the surface of the polycarbonate. Large spherulites could limit the resolution of pattern transfer into polycarbonate at the nanometer-scale by deforming the surface morphologies. More importantly, the polycarbonate mold was successfully adapted to cast a PDMS replica (see FIGS. 14A to 14C) that accurately reproduces the nanograting of the PDMS master. FIGS. 12C, 13C and 14C show the cross-sections of the nanograting on each surface and confirm the fidelity of both lateral and height resolution. The peak widths of the PDMS master (see FIG. 12C) and cast (see FIG. 14C) are 480±25 nm and 470±15 nm respectively. The valleys of the PDMS master (see FIG. 12C) and cast (see FIG. 14C) are 245±10 nm and 250±20 nm respectively. The height of these features is especially consistent between the PDMS master (77±5 nm) and the cast (80±5 nm) as best seen by comparing FIGS. 12C and 14C. Such consistency demonstrates the effectiveness of the molding and casting procedure described herein in the replication of polymeric nanostructures. Compared to most prior art molding methods that are limited in the area they can pattern, large areas (3 cm×3 cm) of defined nanostructures can be patterned using methods 5, 105. Advantageously, a functional polycarbonate mold can be fabricated and used to cast nanometer-scale features by hand on a benchtop in a simple and low-cost manner according to methods 5, 105. With methods 5, 105, nanostructured masters which are compatible with solvent 20 may be accurately molded into a robust polycarbonate mold and, the nanostructures can be subsequently replicated with silicone (e.g. PDMS).

Small pieces of polycarbonate (1.5″×1.5″) were cut from a large sheet to be employed as plates 10 for fingerprint molding. The protective film was removed from one side (e.g. first surface 12), but left on the other side (backside) during the solvent treatment. The polycarbonate surface was first washed with deionized water and ethanol (95%), then dried under nitrogen. To prepare for fingerprinting, the finger was cleaned by washing with warm water and then dried by dabbing with a Kimwipe™.

1.0 mL of 99.8% acetone (by weight) (e.g. solvent 20) was deposited onto the polycarbonate plate with an automatic micropipette and left on first surface for 45 seconds. The finger was then either pressed with mild force or rolled on the surface to produce a fingerprint impression. Rolling was done in a similar manner as to with ink printing: one edge of the finger was pressed then the digit was rolled to the other edge producing a flat print that includes both the edges and center of the fingerprint. Once dried, the protective coating was removed from the backside of polycarbonate plate 10. The plastic fingerprint replicas (e.g. negative molds 40) were imaged using an Epson Perfection™ 1250 scanner or a Nikon™ D5300 DSLR camera equipped with a micro lens. In both cases, the fingerprints were recorded with a black paper background underneath the polycarbonate plate for better contrast. Fingerprint impressions (e.g. negative molds 40) were also imaged using an Olympus™ BX50 polarized light microscope to examine the fingerprinting-related recrystallization process on the polycarbonate surface.

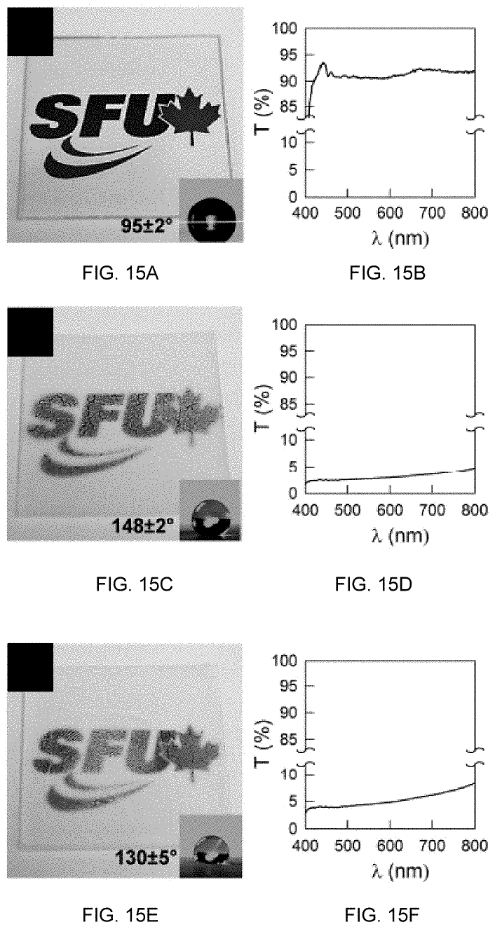

FIG. 15A shows an untreated plate 10 is transparent: the Simon Fraser University logo placed underneath is very clear. In contrast, by comparing FIG. 15A to FIG. 15C, it can be seen that after treatment with acetone (e.g. as is the case in FIG. 15C), polycarbonate plate 10 became more opaque: the Simon Fraser University logo is partially obscured. FIG. 15E shows polycarbonate plate 10 after fingerprinting (e.g. at block 5-4 of the method 5). In FIG. 15E, polycarbonate plate 10 is mostly opaque but impressions left by fingerprint ridges are more transparent. As can be seen by the UV/Vis transmittance spectra shown in FIGS. 15B, 15D and 15F, untreated polycarbonate plate 10 (see FIG. 15B) is largely transparent above 400 nm (e.g. T>90%). In contrast, treated polycarbonate plate 10 (see FIG. 15D) exhibits low transmittance (e.g. T=2˜5%) while fingerprinted plate 10 (see FIG. 15F) has significantly higher transmittance (e.g. T=4˜9%) for the visible region (400-800 nm). Although to the naked eye, the acetone treated does not seem to block ˜90% of incoming light plate (see FIG. 15C), the rather low transmittance (see FIG. 15D) may be due to the intense scattering and refraction of the incident beam by the “roughened” polycarbonate surface. This appeared to be confirmed by collecting transmission spectra with the polycarbonate plate positioned at different angles with respect to the incident beam; as the polycarbonate was moved away from perpendicular, the transmittance decreased significantly.

To further confirm the transformation of polycarbonate from amorphous into a semi-crystalline state, wetting properties of the surface of polycarbonate were investigated. As shown in the inset of FIG. 15A unmodified polycarbonate is moderately hydrophobic and demonstrates a water contact angle of 95±1°. As shown in the inset of FIG. 15C acetone-treated polycarbonate is nearly super-hydrophobic and demonstrates a water contact angle of 145±1°. This may be due to spherulites which provide roughness on the micrometer and nanometer-scales, which reduces the contact area between a water droplet and the surface. As shown in the inset of FIG. 15E fingerprint-molded polycarbonate is between unmodified polycarbonate and acetone-treated polycarbonate and demonstrates a water contact angle of 134±3°.

The inventors examined the quality of fingerprint replicas (e.g. negative molds 40) based on the three levels of physical details that exist in human fingerprints. When a fingerprint is molded onto polycarbonate plate 10 treated with acetone (e.g. solvent 20), the solvated polymer chains (the swollen top layer) form “opaque regions” between fingerprint ridges. Underneath the fingerprint ridges, most of the swollen polycarbonate chains are displaced during fingerprinting, which appeared transparent in the molded fingerprints (see FIG. 15E).

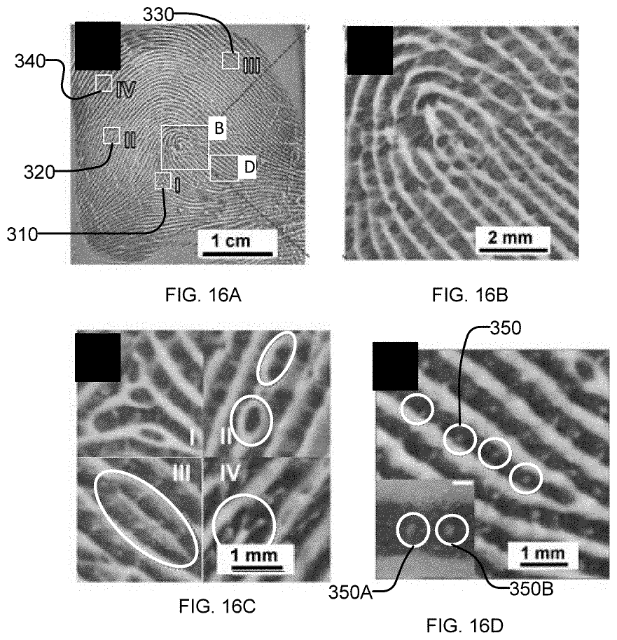

A complete fingerprint image obtained with a desktop scanner and a black background is displayed in FIG. 16A to show first level details. In FIGS. 16B and 16C, selected second level details are evident. For example, the fingerprint core shown in FIG. 16B, which corresponds to region “B” of FIG. 16A, is a useful feature to align and match fingerprints. FIG. 16A shows a delta 310, an island 320, a lake 330, and a bifurcation 340. FIG. 16C shows a magnified view of delta 310 (top left corner), a magnified view of island 320 (top right corner), a magnified view of lake 330 (bottom left corner) and a magnified view of bifurcation 340 (bottom right corner).

Conventionally, sweat pores and other third level details are difficult to replicate due to their small size and depth. These highly distinctive features however, can be resolved in the fingerprints molded on polycarbonate, as can be seen in FIG. 16D which shows a plurality of sweat pores 350 corresponding to region “D” of FIG. 16A. As shown as the inset picture of FIG. 16D, a closed (inactive) sweat pore 350B and an open (active) sweat pore 350A can be distinguished. Visual comparison between originals and molds show that ridge shape and position are precisely replicated. By recording all levels of details in a well-defined manner, method 5 is a viable method of cataloging fingerprints.

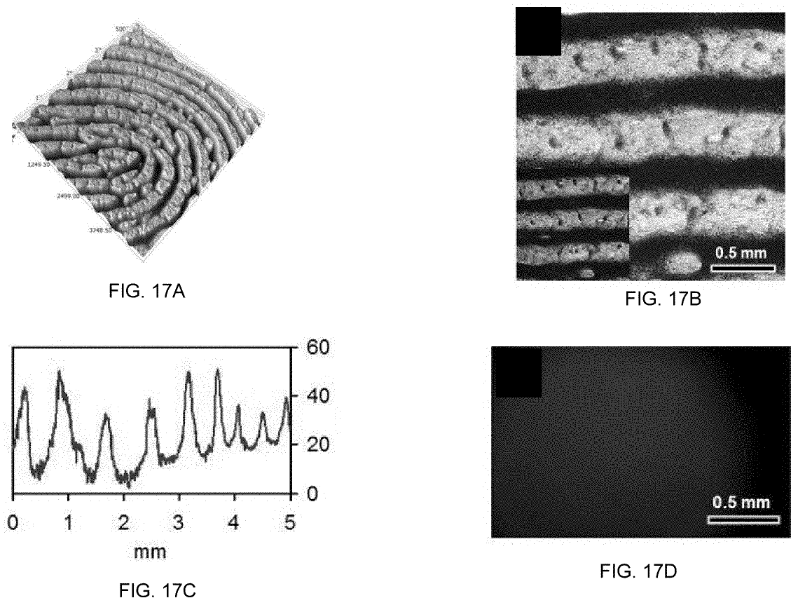

A unique feature of methods 5, 105 is the capability of recording the depth of fingerprint features (e.g. mold features 42). The depth of fingerprint features provides insight into the wear and tear of finger ridges, often associated with age and occupation. Like sweat pores, ridge depth has the potential to allow for positive identification with a much smaller portion of a fingerprint as compared to two dimensional fingerprint replicas. To illustrate this unique feature, a fingerprint-molded polycarbonate plate, as shown in FIG. 17A, was analyzed with a profilometer to examine the ridge height and width. For the particular fingerprint shown here, the average ridge width is between 400 and 600 μm and the height ranges from 30 to 50 μm (as can be seen from FIG. 17C), which is well within the range of ridge dimensions of human fingerprints. FIG. 17B is a polarized optical microscopy image of the FIG. 17A fingerprint. The inset image of FIG. 17B is the same section as FIG. 17B but illuminated at a different angle.

Polycarbonate is of low cost and is chemically stable. It is useful as a fingerprinting substrate because of the rapid and distinct optical property change upon solvent treatment. During the molding process, the surface layer of polycarbonate is softened by solvent 20 (e.g. acetone) to the point that the swollen polymer chains can physically rearrange. When pressed with a master, the swollen polymer is “squeezed” between features of the master (e.g. squeezed into fingerprint ridges and into sweat pores). Generally polycarbonate is produced in the amorphous state as the polymer chains are rigid, making them difficult to crystallize from melt. Once swollen, the polycarbonate chains can adopt a more energetically favorable conformation and rearrange into spherulites (e.g. spherical formation of crystalline polycarbonate regions that grow radially from a central point with amorphous polycarbonate filling in between these nanostructured crystalline domains). The crystallization process occurs rather fast, which is consistent with the observation for the fingerprint replica being stabilized within minutes. The spherulites of semi-crystalline polycarbonate create a rough surface that scatters incoming light; hence it is opaque in appearance. Crystalline polycarbonate is birefringent, which scatters polarized light directionally depending on the incident angle.

It was demonstrated that the polycarbonate surface has been structurally altered by imaging fingerprint-molded and unmodified polycarbonate with a polarized optical microscope (see FIG. 17A). When the angle of propagation of incident light is changed, the color and intensity of scattered light is different (inset of FIG. 17B compared to FIG. 17B) indicating that crystalline polycarbonate domains are present. Within ridge impressions the thin semi-crystalline layer is capable of scattering incident light while still transmitting the majority of the light, appearing bright. Between ridge impressions, the crystalline domains formed are too thick to transmit any light. In comparison, the image for unmodified polycarbonate (FIG. 17D) appears totally dark, as polarized light is not scattered by the amorphous polycarbonate.

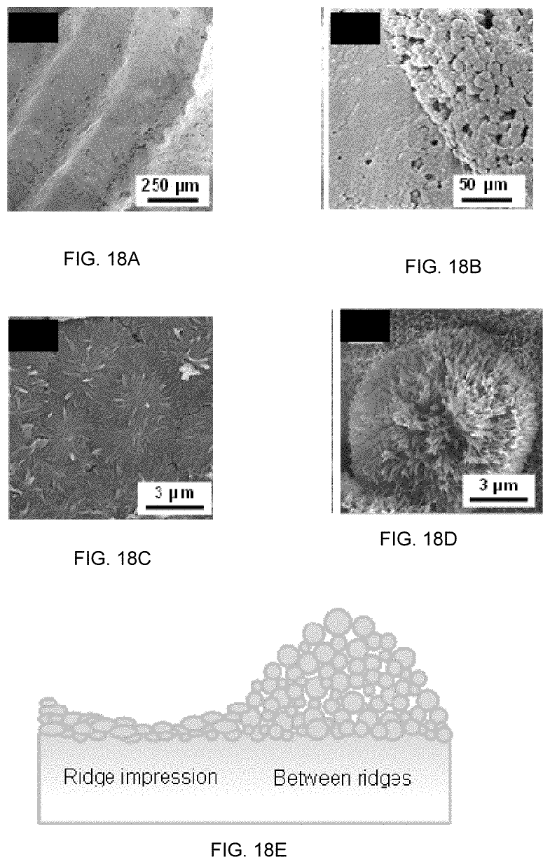

The above proposed structural changes of polycarbonate surface upon solvent-assisted molding of fingerprints were further evaluated with SEM imaging. If no external force is applied, acetone-treated polycarbonate should form a homogeneous multi-layered network of spherulites. Physical force applied by molding motion may disrupt the spherulite formation. FIG. 18A shows a fingerprint molded polycarbonate at low magnification, in which the “outline” of two ridge impressions is easily identified. It is evident that ridges produce flat “valleys” while between them, “porous hills” develop from rearranged polycarbonate chains. The contrast in surface structure is illustrated in FIG. 18B where the ridge impression (bottom left) has a flattened appearance (the spherulite formation is localized and many of them appear fused), while between ridges (top right), the surface appears porous where well-defined spherulites are visible.

With even higher resolution in FIG. 18C, the formation of individual spherulites after swelling with acetone and fingerprinting is visible. Within ridge impressions shown in FIG. 18C, characteristics of spherulite growth are observed on the surface (e.g. the formation of crystalline polycarbonate domains on the surface is observed on the surface). The pressure applied by finger ridges expels solvated polymer from the surface, thus reducing the thickness of the swollen layer and in turn reducing the amount of polymer chains available to develop large spherulites. Between ridges, as shown in FIG. 18D, well-structured spherulite growth can occur as solvated polymer chains are rather abundant, in which case the tendrils of crystalline polycarbonate growth expand radially from the center of each domain to form distinct, large size spherulites. Tighter packing of polymer chains during crystallization could cause polycarbonate to shrink. However, the swollen layer is at the very surface of the polycarbonate plate and does not induce significant deformation. Such structural recrystallization, subsequently, creates the nanoscale roughness responsible for the changes in optical and surface wetting properties. The rough surface not only strongly scatters light, but also provides hydrophobicity by reducing contact between the solid surface and water droplet.

Based on the SEM and polarized microscopy images described above, a hypothetic diagram for the surface morphology of fingerprint-molded polycarbonate is proposed in FIG. 18E. FIG. 18E schematically depicts a ridge impression and associated structural characteristics. The “porous hill” (right side), formed by polymer chains expelled between ridges, consists of well-developed, individual spherulites. The “valley” (left side) consists of a much thinner “layer” of spherulites, which are compressed and appear closely packed. Although the entire surface is eventually covered with spherulites, the fingerprint ridges are visually clear because a thicker semi-crystalline layer is built up between ridges which contributes to the higher opacity in these regions.

Methods 5, 105 have extended applications beyond reproducing fingerprints. In other words, the high fidelity with which methods 5, 105 create fingerprint replicas may be applied to produce highly engineered surfaces. Microfluidic channels have been produced in polycarbonate by methods 5, 105 in place of previously used techniques such as milling or molding with extreme pressure. Using methods 5, 105 may reduce or negate a need for high heat and/or extreme pressure to produce microfluidic devices, which reduces the cost and fabrication complexity. By combining control over surface properties with the tools to imprint micro/nanostructure, various microfluidic devices can be fabricated through the solvent-assisted molding processes described herein.

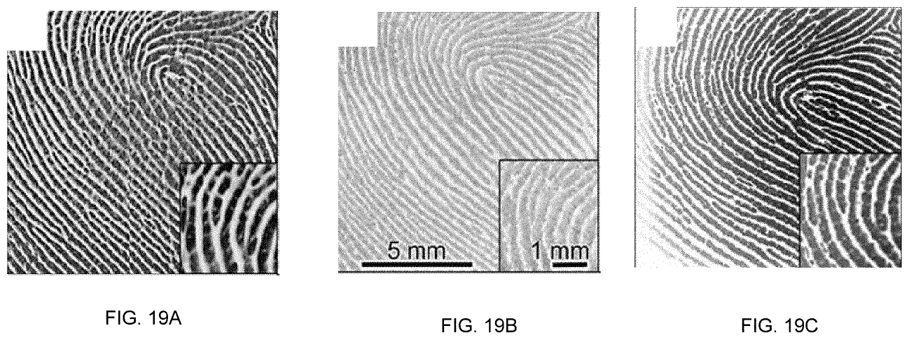

FIG. 19A is an image of a fingerprint mold made with method 5 described herein. FIG. 19B is an image of a fingerprint (i.e. made from the same finger as FIG. 19A) made with a traditional paper inking method. FIG. 19C is an image of a fingerprint (i.e. made from the same finger as FIG. 19A) made with digital scanning. Each of method 5, paper inking and digital scanning techniques may resolve first and second level details. However, the paper inking technique obscures third level details such as ridge edges, and pores. Similarly, due to the low resolution of the digital print in FIG. 19C, third level details are difficult to discern.

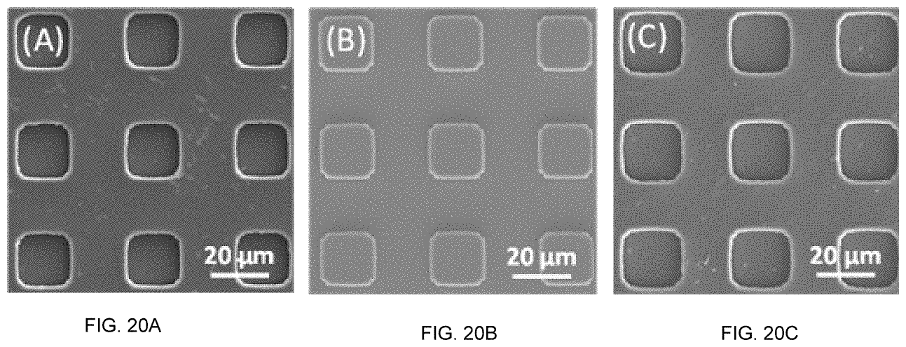

As discussed herein, methods 5 and 105 are not limited to molding fingerprints and/or fingerprint phantoms. For example, micrometer-scaled and nanometer-scaled structures (e.g. nanostructured templates) can be replicated from masters (e.g. pre-fabricated templates) onto polycarbonate replicas. FIGS. 20A to 20C illustrate the replication of microstructures using methods 5, 105. In particular, a micro-structured polycarbonate replica master (see FIG. 20A) was fabricated by solvent-assisted molding (e.g. method 5) with a PDMS stamp. The PDMS stamp was molded from a UV lithographically fabricated SU8 master. The SU8 master was adorned with 20 μm square pits.

The PDMS stamp was used to produce a polycarbonate replica master (see FIG. 20A) of the SU8 master into the polycarbonate (e.g. plate 10) by treating the polycarbonate surface with a thin film of acetone (e.g. solvent 20) for 10 seconds before placing the PDMS stamp on the surface (e.g. first surface 12). A PDMS as cast was made from the FIG. 20A polycarbonate replica master and is adorned with square pillars instead of pits (see FIG. 20B). The square features in FIG. 20B are strictly 20 μm wide and even retain the notched corners present in the FIG. 20A polycarbonate replica master. FIG. 20C displays a polycarbonate replica of the FIG. 20A replica master which was molded from the FIG. 20B PDMS cast using method 105. The replicated square pits of FIG. 20C have the same dimension as the replica master (20 μm) in FIG. 20A. The microscale features on the replica master were successfully molded to PDMS and then cast to a polycarbonate replica of the master shown in FIG. 20C with high fidelity. It should be noted that any types of lithographically prepared solid masters (e.g. silicon, glass, and SU8) may be replicated.

In another experiment, a prefabricated nickel nanostructure bearing a nanoscale array of pits and tracks etched with electron/ion beam technology that produces a holographic security image was used as a nanostructured template. Features on the nickel nanostructure ranged in size from 400 nm to 100 nm depending on the desired optical properties. A PDMS cast of the nickel nanostructure was constructed by pouring 2 grams of h-PDMS (1:1 ratio of parts A and B) over the nickel nanostructure. After the h-PDMS was degassed and cured for 30 minutes at 60° C., a layer of regular PDMS was poured on top to form a flexible backing. The PDMS was degassed for 30 min, cured in the oven at 80° C. for 2 hours, then peeled from the nickel nanostructure.

To replicate the nickel master a thin film of acetone (e.g. solvent 20) in the amount of 0.5 ml for each 1 cm² was applied to the surface (e.g. first surface 12) of a polycarbonate plate (e.g. plate 10) for 10 seconds. Then the PDMS cast was gently placed onto the polycarbonate and 5 PSI of pressure was applied to maintain conformal contact. After the acetone had evaporated the cast and polycarbonate replica were separated by hand.

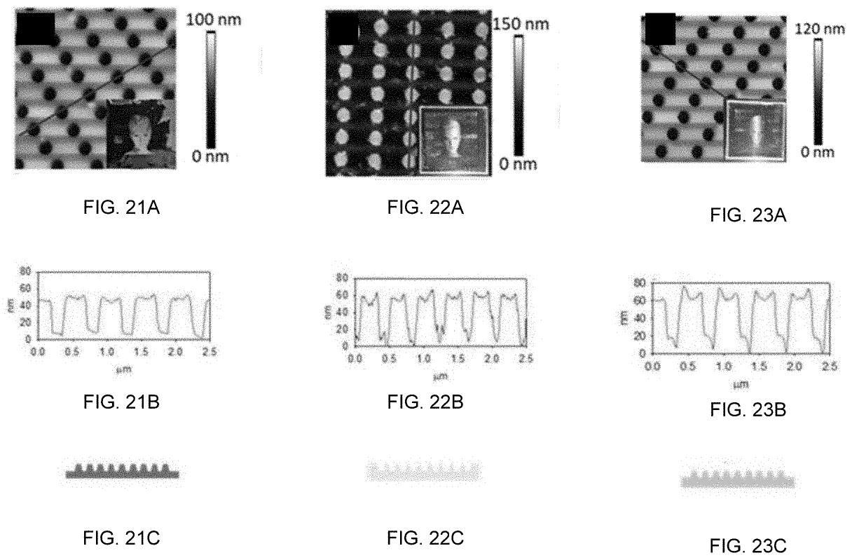

As shown in FIG. 21A, the nickel nanostructure is patterned with pits that are 200±5 nm in width (at the bottom) arranged in rows between troughs which have a width of 125±5 nm. When the nickel nanostructure is used to mold PDMS using method 105, the pits become pillars and the troughs become ridges, respectively (see FIG. 22A). By comparing FIGS. 21B and 21C to FIGS. 22B and 22C, it is apparent that the pattern is well replicated. For example, both features (troughs and pits) are copied without any distortion. As can be seen by comparing the inset images of FIGS. 21A and 22A, the holographic image was not distorted and remained vibrant indicating that regions other than the scanned area were also replicated accurately. The width of pillars on the PDMS was determined to be 210±5 nm, nearly the same as the nickel nanostructure. The ridges in the PDMS mold have a similar width of 130±5 nm.

A polycarbonate replica fabricated using method 5 (shown in FIG. 23A) has the same arrangement of pits and troughs as the master in FIG. 21A without any significant distortion or defects. The pits have the same width (200±5 nm) as the master and troughs have a width of 125±5 nm. This resolution is around 50 nm which makes it comparable with more costly thermal/pressure molding protocols. The fact that the holographic image is reproduced without distortion, demonstrates that this polycarbonate replica may be used in replacement of the precious master.

Significant crystallization (formation of spherulites) on the surface of the polycarbonate was not observed as spherulite formation was prevented by the short acetone treatment time (10 seconds) and the spatial limitation. Large spherulites would jeopardize the resolution of pattern transfer into polycarbonate at the nanoscale by deforming the surface morphologies. Particularly, FIGS. 21C, 22C and 23c show that the cross sections of the pit/pillar array on each surface conserve both the lateral and height dimensions at the nanometer-scale. The diameters of the master and polycarbonate replica pits are consistent (200±5 nm) and the heights of these features are also consistent (45±5 nm in depth/height). Such consistency validates the effectiveness of methods 5, 105 in the replication of designed nanostructures.

Fourier-transform infrared spectroscopy analysis of PDMS after casting and SEM imaging of polycarbonate after molding further reinforce that material is not transferred during molding. As such, polycarbonate replicas can be reused as masters multiple times without any apparent damage or contamination. The robust nature of this approach is clear; numerous polycarbonate replicas can be prepared without the need of any sophisticated instrumentation and clean-room facilities.

Applications of method 5 for fabricating molds and method 105 for casting are varied. For example, method 5 of fabricating molds and method 105 of casting described herein may reduce the cost of producing nanostructures that can help broaden the applications of micrometer-scale and nanometer-scale devices generally. Non-limiting exemplary fields of application include optical filters, micro electromechanical systems, sensors and microfluidic devices. Nanometer-scale molded surfaces fabricated by the methods 5, 105 may be adapted to enhance many applications such as, for example low-flow-resistance and low-fluid-loss microfluidic devices, microfluidics devices that perform protein separations which rely on modified surfaces to localize and control surface adhesion, and PDMS “stamps” (templates) for micro-contact printing which rely on embedded nanostructures to improve ink transfer and reduce residual contamination.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A method for fabricating a nanocontact mold, the method comprising:
providing a plate;
applying a solvent to a first surface of the plate;
allowing the solvent to penetrate from the first surface into the plate, to soften a first region of the plate, the first region of the plate including the first surface;
pressing a master against the first region of the plate after the first region of the plate has softened to thereby deform at least a portion of the first region into a negative mold; and
removing the master from contact with the plate.

2. A method according to claim 1 comprising removing at least some of the solvent from the first region of the plate after allowing the solvent to penetrate from the first surface into the plate to soften the first region of the plate.

3. A method according to claim 1 comprising removing at least some of the solvent from the first region of the plate after pressing the master against the first region of the plate.

4. A method according to claim 1 comprising removing at least some of the solvent from the first region of the plate, wherein removing at least some of the solved from the first region of the plate is effected by pressing the master against the first region of the plate.

5. A method according to claim 2 wherein the at least some of the solvent comprises at least 50% of the solvent applied to the first surface of the plate.

6-7. (canceled)

8. A method according to claim 1 wherein the at least some of the solvent is removed from the first region of the plate between 4 seconds and 120 seconds after applying the solvent to the first surface of the plate.

9. (canceled)

10. A method according to claim 1 wherein the at least some of the solvent is removed from the first region of the plate between 4 seconds and 16 seconds after applying the solvent to the first surface of the plate.

11. A method according to claim 1 wherein the length of time before the at least some of the solvent is removed from the first region is dependent on a desired depth of the first region.

12-14. (canceled)

15. A method according to claim 1 wherein the length of time before the at least some of the solvent is removed from the first region is dependent on a minimum dimension of the features of the master.

16-19. (canceled)

20. A method according to claim 1 wherein the plate comprises a polycarbonate plate.

21. A method according to claim 1 wherein the solvent is acetone.

22. (canceled)

23. A method according to claim 1 wherein the solvent comprises at least 90% acetone (by weight).

24-30. (canceled)

31. A method according to claim 1 wherein a ratio of a volume of solvent applied to the first surface of the plate to a surface area of the first surface of the plate is between 1 mL:300 mm² and 1 mL:600 mm².

32-33. (canceled)

34. A method according to claim 1 wherein the master comprises a nanometer-scale patterned structure.

35. A method according to claim 1 wherein the master is a finger.

36. (canceled)

37. A method of nanocontact casting, the method comprising;
providing a nanocontact mold fabricated according to the method of claim 1;
introducing a silicone solution over the first surface of the plate;
curing the silicone solution on the first surface of the plate at a curing temperature to make a cured silicone cast; and
removing the cured silicone cast from the first surface of the plate.

38. (canceled)

39. A method according to claim 37 comprising fabricating the silicone solution by mixing silicone precursors.

40-42. (canceled)

43. A method according to claim 38 comprising fabricating the silicone solution by mixing the silicone precursors and colour pigment.

44. A method according to claim 38 comprising fabricating the silicone solution by mixing the silicone precursors and conductive particles.

45-54. (canceled)

55. A method according to claim 37 wherein the silicone solution comprises a polydimethylsiloxane (PDMS) solution.

56. A method according to claim 37 wherein the cured silicone cast comprises a nanometer-scale patterned structure.

57. A method according to claim 37 wherein the cured silicone cast comprises a fingerprint phantom.

58-61. (canceled)
